(19) United States
(12) Patent Application Publication
(10) Pub. No.: US 2026/0331566 A1
(43) Pub. Date: Oct. 22, 2026

(54) ANODE-FREE LITHIUM SECONDARY BATTERY HAVING DUAL-COATED ANODE CURRENT COLLECTOR

(71) Applicant: BEI corp, Ansan-si (KR)

(72) Inventors: Myungjun KIM, Seoul (KR); Youngjin YOON, Winchester, MA (US); Changdeuck BAE, Suwon-si (KR)

(21) Appl. No.: 19/232,836

(22) Filed: Jun. 9, 2025

(30) Foreign Application Priority Data
Apr. 14, 2025 (KR) 10-2025-0048276

(51) Int. Cl. H01M 10/0562; H01M 4/13; H01M 4/66; H01M 10/058

(52) U.S. Cl. CPC H01M 10/0562; H01M 4/13; H01M 4/667; H01M 10/058

(57) ABSTRACT

Provided is an anode-free lithium secondary battery including an anode current collector having a dual coating layer, the anode-free lithium secondary battery comprising a cathode active material, a separator, and an electrolyte between a cathode current collector and the anode current collector, wherein the anode current collector is coated with an artificial SEI layer containing a metal, and a natural solid electrolyte interphase (SEI) film is formed on the anode current collector by reaction of at least a part of the artificial SEI layer with the electrolyte when the anode-free lithium secondary battery is first charged.

### BACKGROUND OF THE INVENTION

### Field of the Invention

The present invention relates to an anode-free lithium secondary battery, and more specifically, to an anode-free lithium secondary battery that is capable of suppressing formation of dendrites on an anode current collector and of improving the capacity and lifespan of the battery by forming a dual coating layer.

### Description of the Related Art

Lithium secondary batteries are manufactured by injecting an organic electrolyte or polymer electrolyte between an anode and a cathode, each using a material capable of intercalating and de-intercalating lithium ions, and generate electrical energy by oxidation and reduction reactions when the lithium ions are intercalated and de-intercalated from the cathode and the anode.

The lithium film (lithium layer) generally used in lithium secondary batteries is easily oxidized and melts at relatively low temperatures, which causes problems of difficulty in manufacturing and maintaining performance, and of increased final product price due to high price thereof.

Anode-free lithium secondary batteries that do not use a lithium film (lithium layer) as the anode may solve the problem of safety described above and drastically reduce the process cost.

However, the anode-free lithium secondary batteries have a problem in that dendrites are formed on the anode current collector during charging of the batteries. These dendrites may cause the batteries to swell, resulting in instability of the interface between the electrode and electrolyte during the battery cycle, and shortening the battery lifespan. In addition, these dendrites may pierce the separator, causing an internal short circuit, thermal runaway, and eventually combustion and explosion of the battery.

### PRIOR ART DOCUMENT

### Patent Document

Korean Patent No. 10-2115596

### SUMMARY OF THE INVENTION

Therefore, the present invention has been made in view of the above problems, and it is an object of the present invention to provide an anode-free lithium secondary battery that is capable of suppressing formation of dendrites and improving the capacity and lifespan of the battery using a dual coating layer including an artificial solid electrolyte interphase (SEI), which is previously coated on an anode current collector, and a natural solid electrolyte interphase (SEI), which is a film naturally formed on the anode current collector when the battery is first charged.

In accordance with the present invention, the above and other objects may be accomplished by the provision of an anode-free lithium secondary battery including an anode current collector having a dual coating layer, the anode-free lithium secondary battery including a cathode active material, a separator, and an electrolyte between a cathode current collector and the anode current collector, wherein the anode current collector is coated with an artificial SEI layer containing a metal, and a natural solid electrolyte interphase (SEI) film is formed on the anode current collector by reaction of at least a part of the artificial SEI layer with the electrolyte when the anode-free lithium secondary battery is first charged.

The natural solid electrolyte interphase (SEI) film may be formed on the anode current collector by reaction of an entirety of the artificial SEI layer with the electrolyte when the anode-free lithium secondary battery is first charged.

The natural solid electrolyte interphase (SEI) film may be formed on the artificial SEI layer that remains unreacted by the reaction of a part of the artificial SEI layer and the electrolyte when the anode-free lithium secondary battery is first charged.

The anode current collector may be previously coated with the artificial solid electrolyte interphase (SEI) before the anode current collector contacts the electrolyte.

The electrolyte may be a local high-concentration electrolyte or a fluorinated electrolyte and the artificial SEI layer may contain a mixture of metals selected from a group consisting of transition metals.

The artificial SEI layer may be formed of an Ag—Ti system.

In the Ag—Ti system of the artificial SEI layer, a volume of Ag may be larger than a volume of Ti.

For example, the Ag—Ti system of the artificial SEI layer may contain 5 to 25% of Ti by volume based on a total volume of the Ag—Ti system.

Preferably, the Ag—Ti system of the artificial SEI layer may contain Ag and Ti in a volume ratio of 4:1 to 16:1 based on the total volume of the Ag—Ti system.

More preferably, the Ag—Ti system of the artificial SEI layer may contain Ag and Ti in a volume ratio of 10:1 based on the total volume of the Ag—Ti system.

For example, the Ag—Ti system may be formed such that, when the anode current collector coated with the artificial SEI layer is tested using a copper K-alpha line, a characteristic peak appears at at least one of 2θ=38°, 2θ=44°, 2θ=64°, or 2θ=77° of an X-ray diffraction pattern.

Preferably, the Ag—Ti system may be formed such that, when the anode current collector coated with the artificial SEI layer is tested using the copper K-alpha line, a characteristic peak appears at all of 2θ=38°, 2θ=44°, 2θ=64°, and 2θ=77° of the X-ray diffraction pattern.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B are conceptual diagrams illustrating an anode-free lithium secondary battery having an artificial SEI layer-coated anode current collector according to an embodiment of the present invention;

FIGS. 2A and 2B are conceptual diagrams illustrating an anode-free lithium secondary battery having an artificial SEI layer-free anode current collector as a comparative example.

FIG. 3A is a microscope image showing the surface of the anode current collector coated with the artificial SEI layer and FIG. 3B is a microscope image showing the surface of the anode current collector without the artificial SEI layer as a comparative example;

FIG. 4A is a microscope image showing a cross-section of an anode layer on an anode current collector coated with an artificial SEI layer and FIG. 4B is a microscope image showing a cross-section of an anode layer on an anode current collector without an artificial SEI layer as a comparative example;

FIG. 5 illustrates comparison in capacity retention depending on the number of charge/discharge cycles between when the artificial SEI is provided and when the artificial SEI is not provided;

FIG. 6 illustrates comparison in capacity retention depending on the number of charge/discharge cycles;

FIG. 7 illustrates comparison in the number of charge/discharge cycles of a battery until the state of health of the battery reaches 80%; and

FIG. 8 shows the results of test of the anode current collector coated with the artificial SEI layer using the copper K-alpha line.

### DETAILED DESCRIPTION OF THE INVENTION

Hereinafter, the lithium secondary battery according to embodiments of the present invention will be described in more detail with reference to the following drawings. However, these drawings are provided only as exemplary embodiments for better understanding and should not be construed as limiting the scope of the present disclosure.

Like reference numbers refer to like elements throughout the description of the figures and duplicate explanation thereof will be omitted. The sizes and shapes of respective constituent components may be exaggerated or reduced for clarity.

In the following description of the present invention, detailed descriptions of related art will be omitted when the same may obscure the subject matter of the present invention.

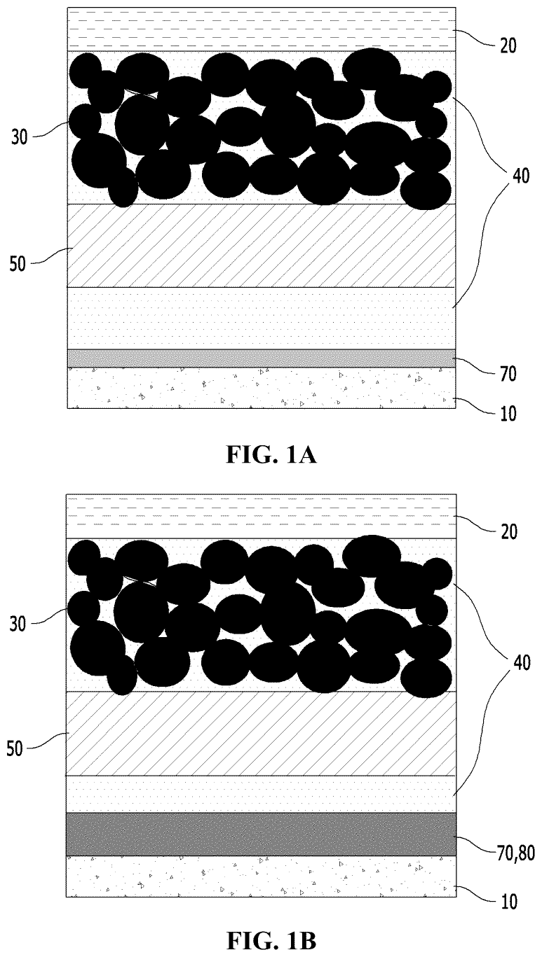

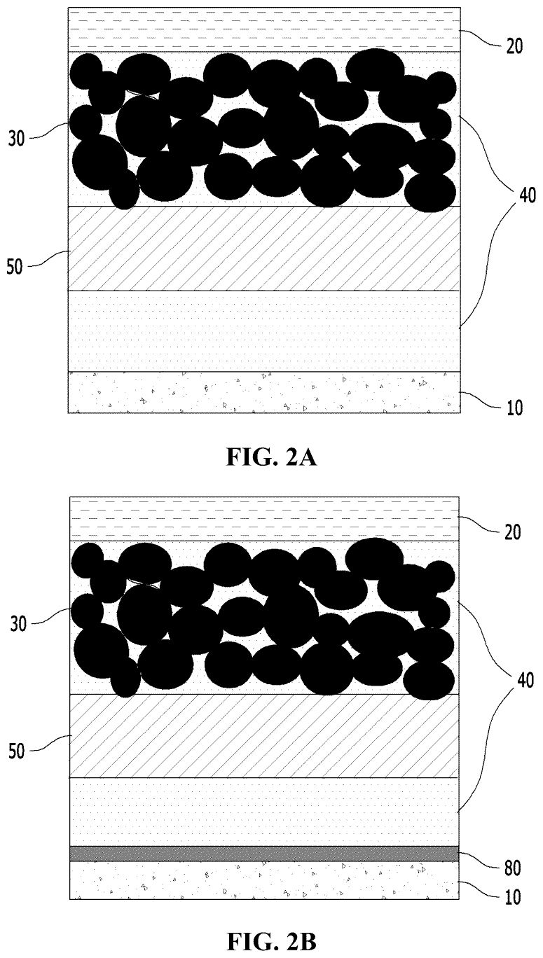

FIGS. 1A and 1B are conceptual diagrams illustrating an anode-free lithium secondary battery having an artificial SEI layer-coated anode current collector according to an embodiment of the present invention, and FIGS. 2A and 2B are conceptual diagrams illustrating an anode-free lithium secondary battery having an artificial SEI layer-free anode current collector as a comparative example.

The cathode layer is not shown in FIGS. 1A to 2B in order to more clearly distinguish between the artificial SEI layer 70 formed on the anode current collector 10 described later and the natural SEI film 80.

For example, during charging, lithium ions separated from a cathode active material may move toward an anode current collector and be reduced on the anode current collector to form an anode layer (i.e., a lithium layer). In addition, during discharging, the anode layer may be oxidized to produce lithium ions and the produced lithium ions may be reduced on the cathode active material.

In the present invention, the anode active material and the anode plate are not provided separately. That is, the present invention relates to an anode-free lithium secondary battery.

Referring to FIGS. 1A to 2B, the anode-free lithium secondary battery may include an anode current collector 10, a cathode current collector 20, a cathode active material 30, an electrolyte 40, and a separator 50. For example, a liquid electrolyte 40 may be provided between the cathode current collector 20 and the anode current collector 10.

Any material may be used for the anode current collector 10 without any particular limitation as long as it has high conductivity and does not cause chemical changes in the lithium secondary battery. For example, the material for the anode current collector 10 may be copper, iron, aluminum, nickel, stainless steel, titanium, tantalum, gold, platinum, or the like. Preferably, the anode current collector 10 may be formed of copper or stainless steel.

The cathode current collector 20 may be formed of aluminum, an aluminum polymer composite, or the like. A separator 50 and a cathode active material 30 may be disposed between the anode current collector 10 and the cathode current collector 20.

The separator 50 is disposed between the anode current collector 10 and the cathode plate formed of the cathode active material 30 to isolate the anode current collector 10 from the cathode active material 30 (or the cathode plate). In addition, the separator 50 may provide a passage for lithium ions to move and may be used without any particular limitation so long as it is commonly used as a separator in a lithium secondary battery.

For example, the separator 50 preferably has low resistance against movement of ions through the electrolyte. For example, the separator 50 may be formed of at least one of polyethylene, polypropylene, or a copolymer of polyethylene or polypropylene, and may also be formed as a multilayered film of two or more layers thereof.

The electrolyte may be a liquid electrolyte. The liquid electrolyte may be a non-aqueous electrolyte solution. The non-aqueous electrolyte solution may contain an electrolyte as a lithium salt and a medium as a solvent.

The lithium salt includes lithium hexafluorophosphate (LiPF₆), lithium tetrafluoroborate (LiBF₄), lithium perchlorate (LiClO₄), lithium hexafluoroarsenate (LiAsF₆), lithium bis(trifluoromethanesulfonyl)imide (LiTFSI), lithium bis(fluorosulfonyl)imide (LiFSI), lithium bis(pentafluoroethanesulfonyl)imide) (LiBETI), lithium difluoro (oxalato) borate (LiDFOB), lithium bis(oxalato) borate (LiBOB), lithium oxalyldifluoroborate (LiODFB), lithium trifluoromethanesulfonylimide (LiTSFI), lithium fluorosulfamoylimide (LiFSAM), lithium difluorosulfonylamide (LiDFSA), lithium trifluoromethanesulfonate (LiTFMS), lithium 4,5-dicyano-2-(trifluoromethyl) imidazole (LiTDI), lithium nitrate (LiNO₃), lithium chloride (LiCl), lithium bromide (LiBr), lithium iodide (LiI), lithium pyridinium hexafluorophosphate (LiPyrF₆), lithium tetrachloroaluminate (LiAlCl₄), 1-ethyl-3-methylimidazolium TFSI+lithium TFSI ([EMIm][TFSI]+LiTFSI), N-propyl-N-methylpyrrolidinium FSI+lithium FSI ([PY13][FSI]+LiFSI), 1-butyl-1-methylpyrrolidinium TFSI+lithium FSI ([BMP][TFSI]+LiFSI), or lithium difluorophosphate (LiPO₂F₂).

The medium may include 1,2-dimethoxyethane (C₄H₁₀O₂, DME), diethylene glycol dimethyl ether (C₆H₁₄O₃, DEGDME), tetraethylene glycol dimethyl ether (C₈H₁₈O₄, TEGDME), glymic ether (C₄H₁₀O₂, mono-/di-/tri-glyme (G1/G2/G3)), tetrahydrofuran (C₄H₈O, THF), 1,3-dioxolane (C₃H₆O₂, DOL), 1,2-diethoxyethane (C₆H₁₄O₂, dDME), ethyl methyl carbonate (C₄H₈O₃, EMC), diethyl carbonate (C₅H₁₀O₃, DEC), dimethyl carbonate (C₃H₆O₃, DMC), fluoroethyl methyl carbonate (C₄H₇FO₃, FEMC), fluoroethylene carbonate (C₃H₃FO₃, FEC), fluorinated dimethoxy ether (C₄H₈F₆O, fluorinated DME (F-DME)), 1,1,2,2-tetrafluoroethyl-2,2,3,3-tetrafluoropropyl ether (C₆H₄F₈O, TTE), hydrofluoroether (CF₃CH₂ or (various), HFE), bis(2,2,2-trifluoroethyl) ether (C₆H₆F₆O, BTFE), trifluoroethyl ether (C₃H₇FO, TFE), sulfolane (C₄H₈O₂S), methyl sulfone (CH₄O₂S), diphenyl sulfone (C₁₂H₁₀O₂S), imedazolinium-based ionic liquid ([C₆H₁₁N₂][TFSI], 1-ethyl-3-methylimidazolium TFSI ([EMIm][TFSI])), pyrrolidinium-based ionic liquid ([C₇H₁₆N][FSI], N-propyl-N-methylpyrrolidinium FSI ([PY13][FSI])), butyl-methylpyrrolidinium-based ionic liquid ([C₉H₂ON][TFSI], butyl-methylpyrrolidinium TFSI ([BMP][TFSI])), acetonitrile (CH₃CN, AN), propylene carbonate (C₄H₆O₃, PC), trifluoropropylene carbonate (C₄H₃F₃O₃, TFP), nitromethane (CH₃NO₂), methyl acetate/ethyl acetate (CH₃COOCH₃/CH₃COOC₂H₅), or a combination thereof. For example, the medium may be a combination of dimethyl carbonate and fluoroethylene carbonate. The liquid electrolyte may further contain an additive in addition to the lithium salt and the medium. For example, the additive may be LiNO₃.

In addition, the electrolyte may be formed as an electrolyte system. The electrolyte system may contain a fully fluorinated electrolyte (fFE), a weak solvent-based electrolyte (WSE), a high-concentration electrolyte (HCE), a localized high-concentration electrolyte (LHCE), a (siloxane-based) silicone-based electrolyte, an ionic liquid (IL), or a combination thereof.

A representative electrolyte salt constituting the electrolyte system may be LiFSI (lithium bis(fluorosulfonyl)imide) or LiTFSI (lithium bis(trifluoromethanesulfonyl)imide).

A representative fully fluorinated solvent is FEC (fluoroethylene carbonate), FEMC (fluoroethyl methyl carbonate), TFEP (trifluoroethyl phosphate), TTE (1,1,2,2-tetrafluoroethyl-2,2,3,3-tetrafluoropropyl ether), or BTFE (bis(trifluoroethyl) ether). A representative weak solvent is DME (dimethoxyethane), DOL (dioxolane), or diglyme. A representative high-concentration (HCE) solvent is dimethoxyethane (DME) or an EC (ethylene carbonate)/DEC (diethyl carbonate) mixture. A representative localized high-concentration (LHCE) solvent is DME or EC/DEC+diluent (TTE, such as HFE (hydrofluoroether)). A representative siloxane)-based solvent may be a polysiloxane-based solvent or MeSi(methyl siloxane). A representative ionic liquid (IL) solvent may be PYR₁₄TFSI (N-methyl-N-butyl pyrrolidinium TFSI), EMI-TFSI (1-ethyl-3-methylimidazolium TFSI), or the like.

The cathode active material 30 may include at least one of lithium-containing nickel-cobalt-aluminum oxide (Li(NiCoAl)O₂, NCA), lithium-containing nickel-cobalt-manganese oxide (Li(NiCoMn)O₂, NCM or NMC), lithium manganese oxide (LiMn₂O₄, LMO), lithium iron phosphate (LiFePO₄, LFP), lithium cobalt oxide (LiCoO₂, LCO), or lithium-containing manganese-iron phosphate (LiMnxFe₁₋ₓMn₄PO₄, LMFP).

When a lithium secondary battery is charged, lithium ions may be separated from the cathode active material 30 and an anode layer (not shown) may be formed on the anode current collector 10.

For example, when the cathode active material 30 is formed of nickel-cobalt-manganese oxide containing lithium, lithium ions may be separated from the cathode active material 30 in accordance with Formula 1 below. The separated lithium ions may be reduced on the anode current collector 10 to form the anode layer.

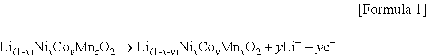

The cathode plate may be formed by pressing the cathode active material 30. That is, the cathode plate may be formed by pressing a cathode active material powder. The pressing of the cathode active material powder may be performed by a known method such as roll pressing.

When the cathode active material 30 is placed on the cathode current collector 20, the cathode active material 30 and the cathode current collector 20 may be pressed together. In this case, the cathode plate may be formed and at the same time, the cathode plate may be attached to the cathode current collector 20. Alternatively, the cathode active material 30 may be formed into the cathode plate by pressing and then the cathode plate may be attached to the cathode current collector 20.

In addition, the cathode plate may further include at least one of a binder material or a conductive material. For example, the cathode plate may be formed by pressing a mixture of at least one of a binder material and a conductive material with the cathode active material 30. For example, the binder material may include a polymer, and known materials may be used as the binder material and the conductive material.

During the first charge of an anode-free lithium secondary battery, a natural solid electrolyte interphase (SEI) film may be formed on the anode current collector by the reaction between the electrolyte 40 and the anode current collector 10. For example, as shown in the following Formula 2 associated with the main reaction, the natural solid electrolyte interphase (SEI) film may be formed on the surface of the anode current collector (e.g., copper) by the reaction between the electrolyte 40 and the anode current collector 10.

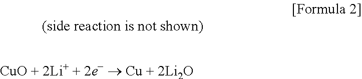

The natural SEI film formed by the reaction (i.e., chemical reaction) between the electrolyte 40 and the anode current collector 10 is already well-known and thus a detailed description thereof is omitted.

Comparative Example shown in FIG. 2B illustrates a state in which a natural SEI film 80 is formed on an anode current collector 10. The natural SEI film may also be referred to as an “NSEI”, an “NSEI film”, or an “NSEI thin film”.

Meanwhile, the present inventors found that, although the natural SEI film 80 is formed on the anode current collector 10 by the reaction between an electrolyte 40 and the anode current collector 10, it is difficult to effectively suppress formation of dendrites on the anode current collector during repeated charging and discharging of the battery.

In order to suppress formation of dendrites, the anode-free lithium secondary battery according to the embodiment of the present invention may have a configuration in which the anode current collector 10 is coated with an artificial SEI layer 70. Here, the artificial SEI (artificial solid electrolyte interphase) may also be referred to as an “ASEI”.

The artificial SEI layer 70 may also be referred to as an “artificial SEI coating layer”, an “artificial SEI film”, an “artificial SEI thin film”, or the like.

As shown in FIG. 1A, the anode current collector 10 may be previously coated with the artificial SEI layer 70 formed of a metal. That is, the anode current collector 10 may be previously coated with the artificial SEI layer 70 before the anode current collector 10 comes into contact with the electrolyte 40.

The anode current collector 10 may be previously coated with the artificial SEI layer 70 before the anode current collector 10 comes into contact with the electrolyte 40. That is, preferably, the anode current collector 10 is previously coated with the artificial SEI layer 70 before the manufacture of the anode-free lithium secondary battery.

Therefore, when the anode-free lithium secondary battery is first charged, the electrolyte and the artificial SEI layer 70 may come into contact and react with each other.

At this time, a natural SEI film 80 may be formed on the anode current collector by reaction of at least a part of the artificial SEI layer 70 and the electrolyte 40.

As shown in FIG. 1B, when the anode-free lithium secondary battery is first charged, the electrolyte 40 may react with at least a part of the artificial SEI layer 70 to form the natural SEI film 80 on the anode current collector 10.

The natural SEI film shown in FIG. 1B may be distinguished from the natural SEI film shown in FIG. 2B and their compositions may be different from each other. This is because the natural SEI film illustrated in FIG. 1B is formed by the reaction of at least a part of the electrolyte 40 and the artificial SEI layer 70, whereas the natural SEI film illustrated in FIG. 2B is formed by the reaction of the electrolyte 40 and the anode current collector 10.

For example, the formation of the natural SEI film through the reaction of at least a part of the artificial SEI layer 70 with the electrolyte 40 may be represented by the following Formulas 3 to 5 associated with the main reaction:

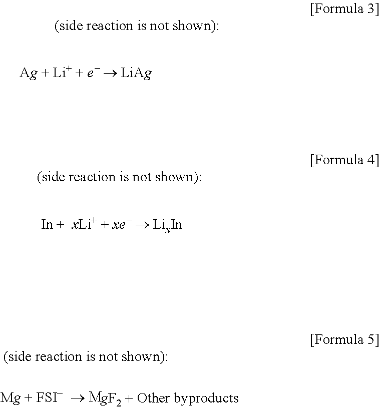

In addition, referring to FIG. 1B, when the anode-free lithium secondary battery is first charged, the natural SEI film 80 may be formed on the anode current collector 10 by the reaction of the entire artificial SEI layer 70 and the electrolyte 40.

On the other hand, the natural SEI film 80 may be formed on the artificial SEI layer 70 that remains unreacted by the reaction of a part of the artificial SEI layer 70 and the electrolyte 40, when the anode-free lithium secondary battery is first charged.

In any case, the artificial SEI layer 70 and the natural SEI film 80 on the anode current collector 10 shown in FIG. 1B may also be referred to as a “dual coating layer”, a “dual film”, a “dual layer”, or the like, since both the artificial SEI layer 70 previously coated on the anode current collector 10 and the natural SEI film 80 are used.

Through experiments, the present inventors found that, when the anode current collector 10 is coated with the artificial SEI layer 70, which is a metal coating layer, the formation of dendrites may be significantly suppressed.

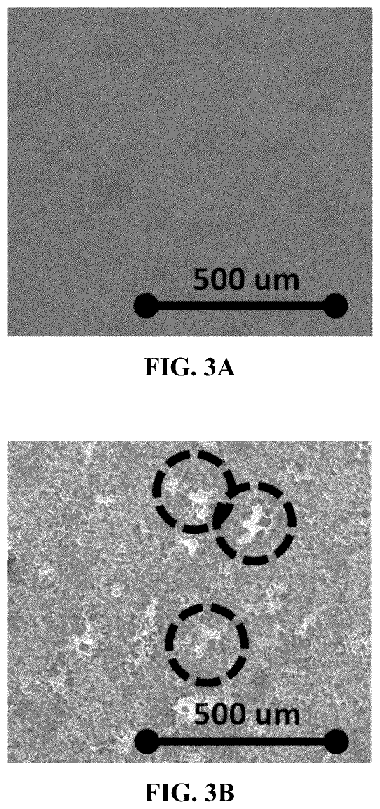

FIG. 3A is a microscope image showing the surface of the anode current collector coated with the artificial SEI layer and FIG. 3B is a microscope image showing the surface of the anode current collector without the artificial SEI layer as a comparative example. Specifically, FIG. 3A is a microscope image showing the surface of the anode current collector coated with an artificial SEI layer after the battery has been repeatedly charged and discharged. In addition, FIG. 3B is a microscope image showing the surface of the anode current collector without an artificial SEI layer after the battery has been repeatedly charged and discharged.

As indicated by the dotted circle in FIG. 3B, a larger number of dendrites with a larger size are formed on the surface of the anode current collector without an artificial SEI layer.

On the other hand, as can be seen from FIG. 3A showing the surface of the anode current collector on which the artificial SEI layer is formed, a smooth surface with suppressed dendrite formation is maintained.

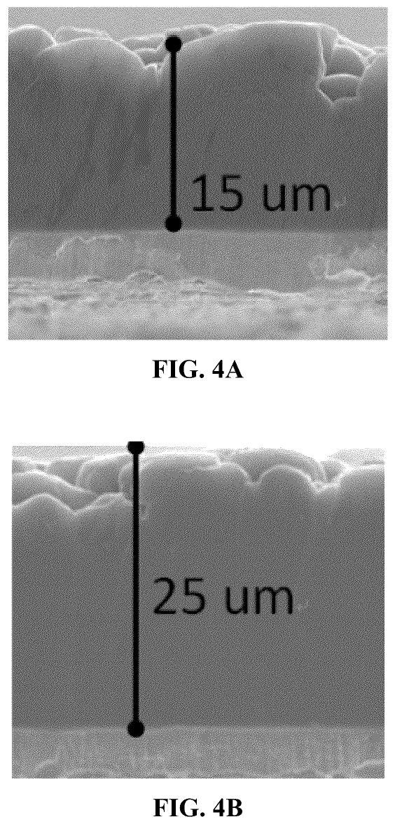

In addition, FIG. 4A is a microscope image showing a cross-section of an anode layer on an anode current collector coated with an artificial SEI layer, and FIG. 4B is a microscope image showing a cross-section of an anode layer on an anode current collector without an artificial SEI layer as a comparative example. Specifically, FIG. 3A is a microscope image showing a cross-section of an anode layer on an anode current collector coated with an artificial SEI layer after the battery has been repeatedly charged and discharged. In addition, FIG. 3B is a microscope image showing a cross-section of an anode layer on an anode current collector without an artificial SEI layer after the battery has been repeatedly charged and discharged.

As can be seen from FIG. 4B, the thickness of the cross-section of the anode layer on the anode current collector without an artificial SEI layer is approximately 25 μm, and the anode layer has a larger thickness due to the formation of dendrites.

On the other hand, as can be seen from FIG. 4A showing the cross-section of the anode layer on the anode current collector on which an artificial SEI layer is formed, the formation of dendrites is suppressed and the thickness of the anode layer is maintained relatively small at approximately 15 μm.

As such, according to the present invention, by previously coating the anode current collector 10 with an artificial SEI layer 70, the formation of dendrites in the anode layer may be suppressed.

Meanwhile, the present inventors conducted an experiment related to the improvement of the lifespan of a lithium secondary battery depending on whether the anode current collector 10 was coated with an artificial SEI layer 70.

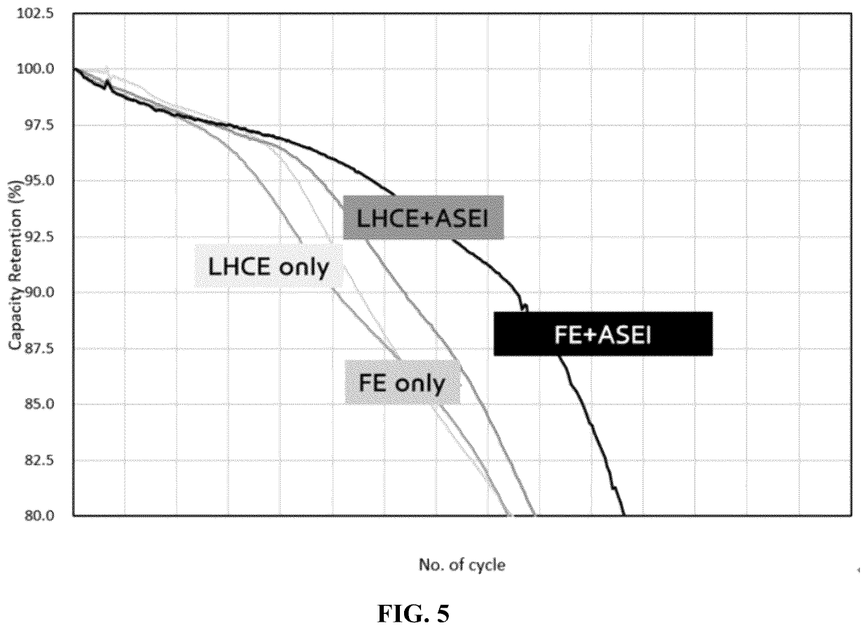

FIG. 5 illustrates comparison in capacity retention depending on the number of charge/discharge cycles between when the artificial SEI is provided and when the artificial SEI is not provided;

Specifically, FIG. 5 is a graph showing comparison in capacity retention depending on the number of charge/discharge cycles when only a natural SEI film formed by the reaction between the anode current collector and the electrolyte was used on the anode current collector, and when both coating the anode current collector with an artificial SEI layer and a natural SEI film formed by the reaction between the artificial SEI layer and the electrolyte were used.

In FIG. 5, the horizontal axis represents the number of charge/discharge cycles and the vertical axis represents the capacity retention.

Referring to FIG. 5, the electrolytes used in the experiment are a localized high-concentration electrolyte (LHCE) and a fluorinated electrolyte (FE).

FIG. 5 illustrates two comparative examples in which the anode current collector is not coated with an artificial SEI layer and two comparative examples in which the anode current collector is previously coated with an artificial SEI layer.

Specifically, Comparative Example 1 (LHCE only) shows that the anode current collector is not coated with an artificial SEI layer and a natural SEI film is formed on the anode current collector by the reaction between the localized high-concentration electrolyte and the anode current collector, and Comparative Example 2 (FE only) shows that the anode current collector is not coated with an artificial SEI layer and a natural SEI film is formed on the anode current collector by the reaction between the fluorinated electrolyte and the anode current collector.

In addition, Comparative Example 3 (LHCE+ASEI) shows that the anode current collector is previously coated with an artificial SEI layer and then a natural SEI film is further formed on the anode current collector by the reaction of the local high-concentration electrolyte and the artificial SEI layer, and Comparative Example 4 (FE+ASEI) shows that the anode current collector is previously coated with an artificial SEI layer and then a natural SEI film is further formed on the anode current collector by the reaction of the fluorinated electrolyte and the artificial SEI layer.

As shown in FIG. 5, compared to Comparative Examples 1 and 2 (LHCE only, FE only) in which the anode current collector is not coated with the artificial SEI layer, in Comparative Examples 3 and 4 (LHCE+ASEI, FE+ASEI) in which the anode current collector is previously coated with the artificial SEI layer, the decrease in the capacity retention depending on the number of repeated charge/discharge cycles is relatively small.

That is, in the same number of charge and discharge cycles, compared to Comparative Examples 1 and 2 (LHCE only, FE only) in which the anode current collector is not coated with the artificial SEI layer, Comparative Examples 3 and 4 (LHCE+ASEI, FE+ASEI) in which the anode current collector is previously coated with the artificial SEI layer exhibit a greater capacity retention.

In other words, when comparing the number of charge and discharge cycles to reach a specific capacity retention (e.g., capacity retention of 80%), Comparative Examples 3 and 4 (LHCE+ASEI, FE+ASEI) in which the anode current collector is previously coated with the artificial SEI layer, a greater number of charge and discharge cycles may be secured compared to Comparative Examples 1 and 2 (LHCE only, FE only) in which the anode current collector is not coated with the artificial SEI layer.

As such, when the anode current collector is previously coated with the artificial SEI layer, the capacity and lifespan of the battery may be relatively increased.

Meanwhile, the present inventors found through experiments that the artificial SEI layer 70 preferably contains a mixture of two or more metals selected from a group consisting of transition metals. For example, the artificial SEI layer 70 may contain a mixture of two metals selected from a group consisting of transition metals in the form of a system.

For example, the artificial SEI layer may be formed as an Ag—Ti system. Here, the Ag—Ti system does not mean an alloy of Ag and Ti, but may mean a state in which Ag and Ti are laminated (coated) on the anode current collector.

The order of lamination of Ag and Ti in the Ag—Ti system on the anode current collector may be arbitrary. For example, Ag may first be laminated on the anode current collector and then Ti may be laminated thereon. On the other hand, Ti may be laminated first on the anode current collector and then Ag may be laminated thereon. In addition, Ag and Ti may be laminated repeatedly and alternately on the anode current collector. That is, Ag and Ti may be laminated in multiple layers on the anode current collector.

The Ag—Ti system may also be referred to as an Ag—Ti layer, an Ag—Ti coating layer, an Ag—Ti film, an Ag—Ti thin film, or the like.

The Ag—Ti system coating for forming the artificial SEI layer on the anode current collector may be performed by a known method such as roll coating, spray coating, slot die coating, blade coating, dry coating, or vacuum coating.

According to the present invention, by coating the anode current collector 10 with an artificial SEI layer 70 formed as the Ag—Ti system, the formation of dendrites in the anode layer may be suppressed when the battery is charged.

Meanwhile, although the example in which the artificial SEI layer is formed of an Ag—Ti system has been described, the artificial SEI layer may also be formed of a system containing indium (In) or magnesium (Mg).

The Ag—Ti system will be described in more detail below with reference to other drawings.

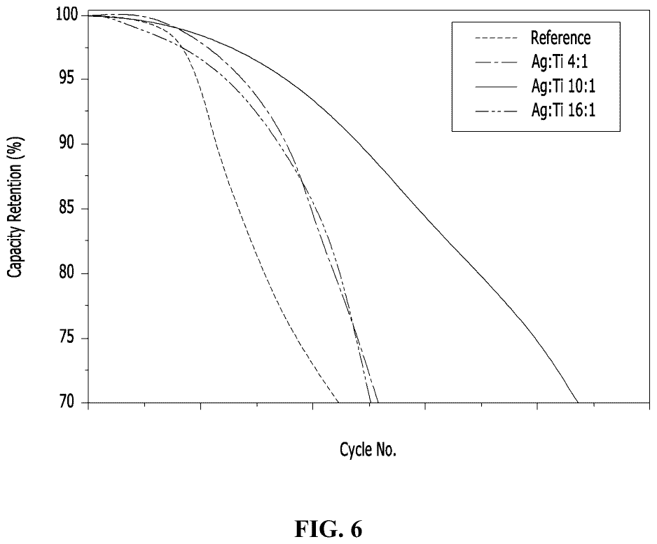

FIG. 6 illustrates comparison between capacity retention depending on the number of charge/discharge cycles. Specifically, FIG. 6 illustrates change in capacity retention (vertical axis) depending on the number of charge/discharge cycles (horizontal axis) in the Ag—Ti system for forming the artificial SEI layer 70.

In FIG. 6, the dotted line represents a reference in which no artificial SEI layer is provided on the anode current collector, the dash-single dotted line represents an example in which Ag and Ti are contained in a ratio of 4:1 based on the entire volume of the Ag—Ti system in the artificial SEI layer, the dash-double dotted line represents an example in which Ag and Ti are contained in a ratio of 16:1 based on the entire volume of the Ag—Ti system in the artificial SEI layer, and the solid line represents an example in which Ag and Ti are contained in a ratio of 10:1 based on the entire volume of the Ag—Ti system in the artificial SEI layer.

As can be seen from FIG. 6, compared to the reference in which an artificial SEI layer formed of Ag—Ti system is not provided, the decrease in capacity retention depending on the number of charge/discharge cycles is relatively small in the example in which the artificial SEI layer formed of Ag—Ti system is provided.

That is, in the same number of charge and discharge cycles, the example in which an artificial SEI layer formed of Ag—Ti system is provided shows a greater capacity retention than the reference in which an artificial SEI layer formed of Ag—Ti system is not provided.

In other words, when comparing the number of charge and discharge cycles to achieve a specific capacity retention (for example, a capacity retention of 80%), the example in which an artificial SEI layer formed of Ag—Ti system is provided may secure a greater number of charge and discharge cycles compared to the reference in which an artificial SEI layer formed of Ag—Ti system is not provided.

As such, when an artificial SEI layer formed of Ag—Ti system is provided, the capacity and lifespan of the battery may be relatively increased.

Meanwhile, the present inventors conducted an experiment to compare the relationship between the state of health (SoH) of the battery and the number of charge/discharge cycles between the case in which an artificial SEI layer formed of Ag—Ti is provided and the case in which an artificial SEI layer formed of Ag—Ti is not provided.

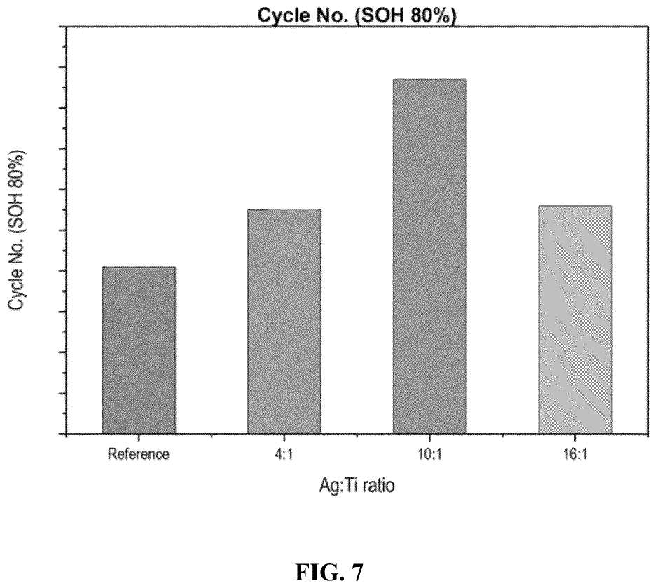

FIG. 7 illustrates comparison in the number of charge/discharge cycles of a battery until the state of health of the battery reaches 80% (i.e., up to SoH 80%).

In general, an electric vehicle (EV) battery is considered to be ready for replacement at an SoH level of 70 to 80%. In other words, SoH 80% means that the battery is aged normally and is still usable, but may be decreased in driving distance, charging speed, or the like compared to the initial state.

As can be seen from FIG. 7, the number of charge/discharge cycles to achieve SoH 80% is greater in the example in which an artificial SEI layer formed of Ag—Ti is provided, compared to the reference in which the artificial SEI layer formed of Ag—Ti is not provided.

That is, when comparing the number of charge/discharge cycles to reach a specific state of health (e.g., SoH 80%) of the battery, the number of charge/discharge cycles may be secured more in the example in which an artificial SEI layer formed of an Ag—Ti system is provided, compared to the reference in which an artificial SEI layer formed of an Ag—Ti system is not provided.

In this way, the capacity and lifespan of the battery may be relatively increased in the example in which an artificial SEI layer formed of an Ag—Ti system is provided.

Meanwhile, as described above, since at least one Ag and at least one Ti are alternately laminated on the anode current collector, the volume of Ag and Ti may be determined based on the thickness of Ag and Ti laminated on the anode current collector.

The present inventors performed an experiment to compare the change in capacity retention depending on the number of charge/discharge cycles based on the Ag volume and the Ti volume in the Ag—Ti system for forming the artificial SEI layer 70.

Referring to FIGS. 6 and 7, the Ag—Ti system of the artificial SEI layer may contain 5 to 25% of Ti by volume based on the total volume of the Ag—Ti system. In other words, the artificial SEI layer may contain 5 to 25% of Ti by volume based on the total volume of the artificial SEI layer.

Preferably, the Ag—Ti system of the artificial SEI layer may contain approximately 9% of Ti by volume based on the total volume of the Ag—Ti system. In other words, the artificial SEI layer may contain Ti in an amount of about 9% of the total volume of the artificial SEI layer.

In addition, the Ag—Ti system of the artificial SEI layer may contain Ag and Ti in a ratio of 4:1 to 16:1 based on the total volume of the Ag—Ti system. In other words, the artificial SEI layer may contain Ag and Ti in a ratio of 4:1 to 16:1 based on the total volume of the artificial SEI layer.

Preferably, the Ag—Ti system of the artificial SEI layer may contain Ag and Ti at a ratio of 10:1 based on the total volume of the Ag—Ti system. In other words, the artificial SEI layer may contain Ag and Ti at a ratio of 10:1 based on the total volume of the artificial SEI layer.

As such, when the anode current collector of a lithium secondary battery is coated with an artificial SEI layer formed of an Ag—Ti system with a specific ratio, the formation of dendrites may be suppressed and the capacity and lifespan of the lithium secondary battery may be increased.

Meanwhile, the present inventors achieved characteristic peaks by testing the anode current collector coated with the artificial SEI layer using the copper K-alpha line. In addition, the present inventors found that the composition of the Ag—Ti system of the artificial SEI layer may be determined based on the characteristic peaks.

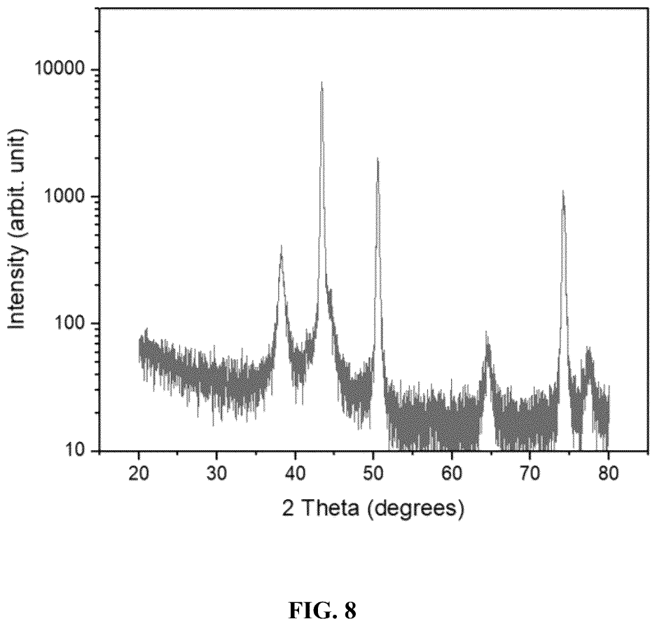

FIG. 8 shows the results of test of the anode current collector coated with the artificial SEI layer using the copper K-alpha line.

As can be seen from FIG. 8, when the anode current collector coated with the artificial SEI layer included in the lithium secondary battery according to the present invention was tested using the copper K-alpha line (k=1.5406 Å), one or more characteristic peaks could be obtained.

Specifically, the present inventors found that, based on the result of the test of the artificial SEI layer formed as the Ag—Ti system using the copper K-alpha line, a characteristic peak appears at at least one of 2θ=38°, 2θ=44°, 2θ=64°, or 2θ=77° of the X-ray diffraction pattern.

In the lithium secondary battery according to the embodiment of the present invention, when the anode current collector coated with the artificial SEI layer is tested using the copper K-alpha line, the Ag—Ti system may be formed such that a characteristic peak appears at at least one of 2θ=38°, 2θ=44°, 2θ=64°, or 2θ=77° of the X-ray diffraction pattern. That is, in the lithium secondary battery according to an embodiment of the present invention, the characteristics of the Ag—Ti system (for example, at least one of the volume ratio of Ag and Ti, the laminate thickness, or the number of laminates) may be determined such that a characteristic peak appears at at least one of 2θ=38°, 2θ=44°, 2θ=64°, or 2θ=77° in an X-ray diffraction pattern.

More specifically, the present inventors found that, when testing the artificial SEI layer formed of a specific ratio of Ag—Ti system (e.g., Ag:Ti=10:1) using the copper K-alpha line, characteristic peaks appear at all of 2θ=38°, 2θ=44°, 2θ=64°, and 2θ=77° of the X-ray diffraction pattern.

Preferably, when testing the anode current collector coated with the artificial SEI layer using the copper K-alpha line in the lithium secondary battery according to the embodiment of the present invention, the Ag—Ti system may be formed such that characteristic peaks appear at all of 2θ=38°, 2θ=44°, 2θ=64°, and 2θ=77° of an X-ray diffraction pattern. That is, the characteristics of the Ag—Ti system (for example, at least one of the volume ratio of Ag and Ti, the laminate thickness, or the number of laminates) in the lithium secondary battery according to the embodiment of the present invention may be determined such that characteristic peaks appear at all of 2θ=38°, 2θ=44°, 2θ=64°, and 2θ=77° of the X-ray diffraction pattern.

The 20 angles are approximate values in the test result graph, and more accurate 2θ angles at which characteristic peaks appear may be 2θ=38.2°, 2θ=44.3°, 2θ=64.5°, and 2θ=77.5°.

As such, according to the present invention, the characteristics of the Ag—Ti system for forming the artificial SEI layer (for example, at least one of the volume ratio of Ag and Ti, the laminate thickness, or the number of laminates) may be determined by testing the anode current collector coated with an artificial SEI layer using a copper K-alpha line.

As is apparent from the above description, an anode-free lithium secondary battery capable of suppressing formation of dendrites on an anode current collector and improving the capacity and lifespan may be provided using a dual coating layer including an artificial SEI pre-coated on the anode collector and a natural SEI.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### National Research and Development Project Supporting the Invention

1. Project Assignment Number: 2410000627
2. Project Number: RS-2024-00410241
3. Ministry: South Korean Ministry of Trade, Industry and Energy
4. Project Management (Specialized) Organization: Korea Institute of Industrial Technology Planning and Evaluation
5. Research Project Name: Automotive Industry Technology Development (R&D)
6. Research Title: Development of Next-Generation Lithium Metal Battery for Electric Vehicles with Energy Density and Safety through Lithium Dendrite Growth Suppression
7. Project Execution Organization: BEI Lab Co. Ltd.
8. Research Period: 2024 Apr. 1~2026 Dec. 31

### [National Research and Development Project Supporting the Invention]

1. Project Assignment Number: 1711195872
2. Project Number: RS-2023-00247245
3. Ministry: Ministry of Science and ICT
4. Project Management (Specialized) Organization: Korea Institute of Industrial Technology Planning and Evaluation
5. Research Project Name: STEAM Research (R&D)
6. Research Title: Development of multi-angle, multi-scale data fusion type lithium secondary battery design artificial intelligence platform
7. Project Execution Organization: BEI Lab Co. Ltd.
8. Research Period: 2023 Apr. 1~ 2027 Dec. 31

What is claimed is:

1. An anode-free lithium secondary battery comprising an anode current collector having a dual coating layer,
the anode-free lithium secondary battery comprising a cathode active material, a separator, and an electrolyte between a cathode current collector and the anode current collector,
wherein the anode current collector is coated with an artificial SEI layer containing a metal, and
a natural solid electrolyte interphase (SEI) film is formed on the anode current collector by reaction of at least a part of the artificial SEI layer with the electrolyte when the anode-free lithium secondary battery is first charged.

2. The anode-free lithium secondary battery according to claim 1, wherein the natural solid electrolyte interphase (SEI) film is formed on the anode current collector by reaction of an entirety of the artificial SEI layer with the electrolyte when the anode-free lithium secondary battery is first charged.

3. The anode-free lithium secondary battery according to claim 1, wherein the natural solid electrolyte interphase (SEI) film is formed on the artificial SEI layer that remains unreacted by the reaction of a part of the artificial SEI layer and the electrolyte when the anode-free lithium secondary battery is first charged.

4. The anode-free lithium secondary battery according to claim 1, wherein the anode current collector is previously coated with the artificial solid electrolyte interphase (SEI) layer before the anode current collector contacts the electrolyte.

5. The anode-free lithium secondary battery according to claim 1, wherein the electrolyte is a local high-concentration electrolyte or a fluorinated electrolyte, and the artificial SEI layer comprises a mixture of metals selected from a group consisting of transition metals.

6. The anode-free lithium secondary battery according to claim 5, wherein the artificial SEI layer is formed of an Ag—Ti system.

7. The anode-free lithium secondary battery according to claim 6, wherein, in the Ag—Ti system of the artificial SEI layer, a volume of Ag is larger than a volume of Ti.

8. The anode-free lithium secondary battery according to claim 6, wherein the Ag—Ti system of the artificial SEI layer contains 5 to 25% of Ti by volume based on a total volume of the Ag—Ti system.

9. The anode-free lithium secondary battery according to claim 6, wherein the Ag—Ti system of the artificial SEI layer contains Ag and Ti in a volume ratio of 4:1 to 16:1 based on the total volume of the Ag—Ti system.

10. The anode-free lithium secondary battery according to claim 9, wherein the Ag—Ti system of the artificial SEI layer contains Ag and Ti in a volume ratio of 10:1 based on the total volume of the Ag—Ti system.

11. The anode-free lithium secondary battery according to claim 6, wherein the Ag—Ti system is formed such that, when the anode current collector coated with the artificial SEI layer is tested using a copper K-alpha line, a characteristic peak appears at at least one of 2θ=38°, 2θ=44°, 2θ=64°, or 2θ=77° of an X-ray diffraction pattern.

12. The anode-free lithium secondary battery according to claim 11, wherein the Ag—Ti system is formed such that, when the anode current collector coated with the artificial SEI layer is tested using the copper K-alpha line, a characteristic peak appears at all of 2θ=38°, 2θ=44°, 2θ=64°, and 2θ=77° of the X-ray diffraction pattern.
